(19) United States
(12) Patent Application Publication
(10) Pub. No.: US 2014/0260922 A1
(43) Pub. Date: Sep. 18, 2014

(54) MATRIX TRANSDUCTION SYSTEM

(71) Applicant: JAMES EDWARD JENNINGS, Superior, CO (US)

(72) Inventor: JAMES EDWARD JENNINGS, Superior, CO (US)

(21) Appl. No.: 13/844,999

(22) Filed: Mar. 17, 2013

(51) Int. Cl. G10H 3/14

(52) U.S. Cl. CPC G10H 3/143
USPC 84/731

(57) ABSTRACT

An ultrasonic oscillation frequency power amplification circuit is disclosed herein having improved power and frequency receiver characteristics. The power circuit is characterized by having atmospheric capacitance of device, octave controlled electronic amplify resonator antenna vessel. As the resonator is far more sensitive to audio feedback than any semi-acoustic guitar, the design of these soundboard is extremely critical, specialized and may incorporate feedback by piezoelectric doping. Organic music is accomplished by incorporating external or environmental energy in the performance by means of ultrasonic transducers. The plugged in sensation is accomplished by sensors. Audience handheld Headstock amplifier absorbs feedback while providing energy through an interactive interface device for concert participants.

### CROSS REFERENCE TO RELATED APPLICATIONS

NONE

### BACKGROUND OF THE INVENTION

1. Field of the Invention

The present invention relates generally to Matrix Transduction System and music circuits, and in particular, to receiving and fabricating methods for providing improved bandwidth performance and power handling capability of frequency power devices and circuits. My invention relates to Power frequency/power devices wireless telegraphy, music key note layout and more particularly to a piezoelectric oscillation-tube resonator which, in addition to performing the usual functions of such detectors, may be used as a tuning device, Amplifying resonator and as a receiver transistor, and which has a variety of other uses.

2. Description of Related Art

The “Fleming valve” was an evacuated glass envelope in which a light-bulb-style metallic filament, fed by low voltage and sucking high current, incandescent at 2000° F. This creates an electrical activity (or, in quantum parlance, “electron flow”) that conducts unidirectional through vacuum to another nearby element, a metallic plate charged to a high positive potential. Thus was a rectifier, and hence also a frequency detector. Lee DeForest discovered that electrical activities within a tube can be leveraged at will by applying small fluctuations to a metallic grid interposed between filament and plate. Jimi Hendrix music expanded range, feedback and amplification.

In music, an octave (Latin octavus: eighth) or perfect octave is the interval between one musical pitch and another with half or double its frequency. The octave relationship is a natural phenomenon that has been referred to as the “basic miracle of music”, the use of which is “common in most musical systems”. It may be derived from the harmonic series as the interval between the first and second harmonics. The octave has occasionally been referred to as a diapason. For example, if one note has a frequency of 440 Hz, the note an octave above it is at 880 Hz, and the note an octave below is at 220 Hz. The ratio of frequencies of two notes an octave apart is therefore 2:1. Further octaves of a note occur at 2n times the frequency of that note (where n is an integer), such as 2, 4, 8, 16, etc. and the reciprocal of that series. For example, 55 Hz and 440 Hz are one and two octaves away from 110 Hz because they are 0.5 (or 2-1) and 4 (or 22) times the frequency, respectively.

A resonator guitar or resophonic guitar is an acoustic guitar whose sound is produced by one or more spun metal cones (resonators) instead of the wooden sound board (guitar top/face). Resonator guitars were originally designed to be louder than regular acoustic guitars, which were overwhelmed by horns and percussion instruments in dance orchestras. They became prized for their distinctive sound, however, and found life with several musical styles (most notably bluegrass and the blues) well after electric amplification solved the issue of inadequate guitar sound levels.

Bioelectricity: Bioelectromagnetism (sometimes equated with bioelectricity) refers to the electrical, or electromagnetic fields produced by living cells, tissues or organisms. Examples include the cell membrane potential and the electric currents that flow in nerves and muscles, as a result of action potentials. ‘Bioelectromagnetism’ is somewhat similar to bioelectromagnetics, which deals with the effect on life from external electromagnetism; yet such an effect also falls under the definition of ‘bioelectromagnetism’. Human body has capacity 25,000 BTU equal to 125 volt battery.

A kilowatt is a unit of power. This means that it is an instantaneous measure of consumption rate. To be specific, a kilowatt is a thousand watts. A watt is a joule per second. And a joule is a unit of energy. So, kilowatts are a measure of energy used per time. To use a familiar simile, kilowatts are like miles per hour in your car. Kilowatts tell you how fast you are using energy.

Energy in electronic elements: Electric potential energy, or electrostatic potential energy, is a potential energy (measured in joules) that results from conservative Coulomb forces and is associated with the configuration of a particular set of point charges within a defined system. The term “electric potential energy” is used to describe the potential energy in systems with time-variant electric fields, while the term “electrostatic potential energy” is used to describe the potential energy in systems with time-invariant electric fields.

Capacitance is the ability of a body to store an electrical charge. Any body or structure that is capable of being charged, either with static electricity or by an electric current, exhibits capacitance. A common form of energy storage device is a parallel-plate capacitor. In a parallel plate capacitor, capacitance is directly proportional to the surface area of the conductor plates and inversely proportional to the separation distance between the plates. If the charges on the plates are +q and −q, and V gives the voltage between the plates, then the capacitance C is given by

C=Q/V.

The capacitance is a function only of the physical dimensions (geometry) of the conductors and the permittivity of the dielectric. It is independent of the potential difference between the conductors and the total charge on them.

Piezoelectricity is the combined effect of the electrical behavior of the material:

D=∈E

where D is the electric charge density displacement (electric displacement), ∈ is permittivity and E is electric field strength, and

S=sT Hooke's Law

where S is strain, s is compliance and T is stress.

In the case of a closed path in the presence of a varying magnetic field, the integral of the electric field around a closed loop may be nonzero; one common application of the concept of emf, known as “induced emf” is the voltage induced in a such a loop. The “induced emf” around a stationary closed path C is:

∈= [symbol] cE·dl,

where now E is the entire electric field, conservative and non-conservative, and the integral is around an arbitrary but stationary closed curve C through which there is a varying magnetic field. Note that the electrostatic field does not contribute to the net emf around a circuit because the electrostatic portion of the electric field is conservative (that is, the work done against the field around a closed path is zero).

Copolymers: Copolymers of PVDF are also used in piezoelectric and electrostrictive applications. One of the most commonly-used copolymers is P(VDF-trifluoroethylene), usually available in ratios of about 50:50 wt % and 65:35 wt % (equivalent to about 56:44 mol % and 70:30 mol %). Another one is P(VDF-tetrafluoroethylene). They improve the piezoelectric response by improving the crystallinity of the material.

A novel electrospun TPU/PVdF porous fibrous polymer electrolyte for lithium ion batteries. Novel blend-based gel polymer electrolyte (GPE) films of thermoplastic polyurethane (TPU) and poly(vinylidene fluoride) (PVdF) (denoted as TPU/PVdF) have been prepared by electrospinning. The electrospun thermoplastic polyurethane-co-poly (vinylidene fluoride) membranes were activated with a 1M solution of LiClO4 in EC/PC and showed a high ionic conductivity about 1.6 mS cm-1 at room temperature. The electrochemical stability is at 5.0 V versus Li+/Li, making them suitable for practical applications in lithium cells. Cycling tests of Li/GPE/LiFePO4 cells showed the suitability of the electrospun membranes made of TPU/PVdF (80/20, w/w) for applications in lithium rechargeable batteries.

A novel high-performance gel polymer electrolyte membrane basing on electrospinning technique for lithium rechargeable batteries. Nonwoven films of composites of thermoplastic polyurethane (TPU) with different proportion of poly(vinylidene fluoride) (PVdF) (80, 50 and 20%, w/w) are prepared by electrospinning 9 wt % polymer solution at room temperature. Then the gel polymer electrolytes (GPEs) are prepared by soaking the electrospun TPU-PVdF blending membranes in 1 M LiClO4/ethylene carbonate (EC)/propylene carbonate (PC) for 1 h. The gel polymer electrolyte (GPE) shows a maximum ionic conductivity of 3.2×10-3 S cm-1 at room temperature and electrochemical stability up to 5.0 V versus Li+/Li for the 50:50 blend ratio of TPU:PVdF system. At the first cycle, it shows a first charge-discharge capacity of 168.9 mAh g-l when the gel polymer electrolyte (GPE) is evaluated in a Li/PE/lithium iron phosphate (LiFePO4) cell at 0.1 C-rate at 25° C. TPU-PVdF (50:50, w/w) based gel polymer electrolyte is observed much more suitable than the composite films with other ratios for high-performance lithium rechargeable batteries. Selenium, notable use is in power DC surge protection

### OBJECTS AND SUMMARY OF THE INVENTION

The present invention antenna vessel sensor circuitry has been accomplished under the circumstances in view. According to one aspect of the present invention, the multipurpose MTS receiver is optionally equipped with a LED lamp and a rechargeable battery for illumination. According to another aspect of the present invention, the resonator receiver comprises a power control unit, which uses a piezoelectric component to amplify frequency for charging the rechargeable battery when battery power is low and when electric service supply is not available.

### Electronic Keyboards

Electronic keyboards have switches under each key. Depressing a key connects a circuit, which triggers tone generation. Most keyboards use a keyboard matrix circuit, in which eight rows and eight columns of wires cross—thus, 16 wires can provide (8×8=) 64 crossings, which the keyboard controller scans to determine which key was pressed. The problem with this system, is that it provides only a crude binary on/off signal for each key. Better electronic keyboards employ two sets of switches for each key that are slightly offset. By determining the timing between the activation of the first and second switches, the velocity of a key press can be determined—greatly improving the performance dynamic of a keyboard. The best electronic keyboards have dedicated circuits for each key providing polyphonic aftertouch.

According to still another aspect of the present invention MTS system, the resonator frequency receiver comprises a circuit unit for receiving resonator broadcasting signals, and a function mode touch display unit, which uses a speaker for voice output, a screen for data display, controller, processor and a selector key for frequency selection. Ultrasonic sensors (also known as transceivers when they both send and receive) work on a principle similar to radar or sonar which evaluate attributes of a target by interpreting the echoes from radio or sound waves respectively. Ultrasonic sensors generate high frequency sound waves and evaluate the echo which is received back by the sensor. Sensors calculate the time interval between sending the signal and receiving the echo to determine the distance to an object. An ultrasonic transducer is a device that converts energy into ultrasound, or sound waves above the normal range of human hearing. While technically a dog whistle is an ultrasonic transducer that converts mechanical energy in the form of air pressure into ultrasonic sound waves, the term is more apt to be used to refer to piezoelectric transducers that convert electrical energy into sound. Piezoelectric crystals have the property of changing size when a voltage is applied, thus applying an alternating current (AC) across them causes them to oscillate at very high frequencies, thus producing very high frequency sound waves. The location at which a transducer focuses the sound can be determined by the active transducer area and shape, the ultrasound frequency, and the sound velocity of the propagation medium.

### Detectors

In a crystal oscillator circuit the filter is a piezoelectric crystal (commonly a quartz crystal). The crystal mechanically vibrates as a resonator, and its frequency of vibration determines the oscillation frequency. Crystals have very high Q-factor and also better temperature stability than tuned circuits, so crystal oscillators have much better frequency stability than LC or RC oscillators. They are used to stabilize the frequency of most radio transmitters, and to generate the clock signal in computers and quartz clocks. Crystal oscillators often use the same circuits as LC oscillators, with the crystal replacing the tuned circuit; the Pierce oscillator circuit is commonly used. Quartz crystals are generally limited to frequencies of 30 MHz or below.

Surface acoustic wave (SAW) devices are another kind of piezoelectric resonator used in crystal oscillators, which can achieve much higher frequencies. They are used in specialized applications which require a high frequency reference, for example, in cellular telephones. Since piezoelectric crystals generate a voltage when force is applied to them, the same crystal can be used as an ultrasonic detector. Some systems use separate transmitter and receiver components while others combine both in a single piezoelectric transceiver. Systems typically use a transducer which generates sound waves in the ultrasonic range, above 18,000 hertz, by turning electrical energy into sound, then upon receiving the echo turn the sound waves into electrical energy which can be measured and displayed.

The present invention provides an organic music experience as if plugged individually by audience participation and incorporating frequency components contributing to frequency band.

### BRIEF DESCRIPTION OF THE DRAWINGS

FIGS. 1-2 are views of enharmonic keyboards according to the present invention.

FIG. 3 is a resonator matrix transducer according to the invention.

FIG. 4-5 is a guitar matrix resonator according to the present invention.

FIG. 6 is a handheld guitar headstock matrix resonator according to the present invention.

FIG. 7 is a handheld guitar headstock matrix resonator according to the present invention.

FIG. 8 is a power frequency circuit diagram according to the present invention.

FIG. 9 is a schematic circuitry diagram of a AMP transducer according to the invention.

FIG. 10 is a schematic circuitry diagram of a AMP transducer according to the invention.

FIG. 11 is a schematic circuitry diagram of a AMP transducer according to the invention.

### BRIEF DESCRIPTION OF THE INVENTION

Some electric guitar and electric bass guitar models feature piezoelectric pickups, which function as transducers to provide a sound closer to that of an acoustic guitar with the flip of a switch or knob, rather than switching guitars. Those that combine piezoelectric pickups and magnetic pickups are sometimes known as hybrid guitars.

Piezoelectric, or piezo, pickups represent another class of pickup. These employ piezoelectricity to generate the musical signal and are popular in hybrid electro-acoustic guitars. A crystal is located under each string, usually in the saddle. When the string vibrates, the shape of the crystal is distorted, and the stresses associated with this change produce tiny voltages across the crystal that can be amplified and manipulated. Some piezo-equipped guitars use what is known as a hexaphonic pickup. “Hex” is a prefix meaning six. In a hexaphonic pickup separate outputs are obtained from discrete piezoelectric pickups for each of the six strings.

Piezoelectric transducer tube bulb (silica, pvdf) with antenna embedded or atopic of a piezoelectric ceramic sensor oscillator resonator, pickups and strings. The “Pizoe” alternately contains filaments (halogen, mercury, tungsten), Low pressure inert gas (argon, nitrogen, krypton, xenon) and stand alone functionality comprising touch screen, transceiver, controller, processor, and button. A small amount of sound energy is reflected by objects in front of the device and returned to the detector, another piezoelectric transducer. The receiver amplifier sends these reflected signals (echoes) to a micro-controller which times them to determine how far away the objects are, by using the speed of sound in air.

The source of radio frequencies convertible to direct current by the circuit shown may include sources of high frequency, low frequency (LF), very low frequency (VLF) and extremely low frequency (ELF) radio waves as well as seismic vibration of the earth's magnetic fields.

### DETAILED DESCRIPTION OF THE PREFERRED EMBODIMENT

Start on A and you get the natural minor 70 pattern, A, B, C, D, E, F, G. But suppose you want to play something using that same pattern of steps but starting higher or lower? If that's what you want, you'll need to add some in-between notes, which are represented by the black keys 6&7. To play the major pattern starting on F, for example, you'll need to add a Bb, a lower form of B, between the A and the B. To play it starting on G you'll need to use a higher F, F#. This is the origin of the FIG. 1 & FIG. 2 black keys 100,200,300,600, which are now found between every pair of white keys that is separated by a whole step.

Between B and C and between E and F there is just a half step—no room there for a black key. But there is a reason to have a “B#” 6 and an “E#7.” For just one example, if you have written a G# in your music and want to make it the root of a major harmony you'll need a major third above it. A third brings you to the third letter, B, but to be major (4 half steps wide) it has to be a raised B: B#. You can't write C as a substitute because that wouldn't be a major harmony; it would confuse the band. C would be a diminished fourth above G# and would have different musical implications.

Since there's no black key between B and C you'll be playing that B# on the same piano key used for C, but that's part of the compromise that makes the piano workable. There was a time when musicians tried making keyboards with separate keys for B# and C, Fb and E, F# and Gb, and all the others, each tuned slightly different—but such keyboards were expensive to make and difficult to use—some had 53 keys to the octave 75. Musicians compromised by tuning just 12 keys in such a way that C could pass for B#, and so on. To sum up: B#6 and E#7 can indeed be part of a scale, depending on the tonic (starting note) of the scale. In music theory, an enharmonic scale is “an [imaginary] gradual progression by quarter tones” or any “[musical] scale proceeding by quarter tones”. The enharmonic 61 scale uses dieses (divisions) nonexistent on most keyboards, since modern standard keyboards have only half-tone dieses.

Keyboard Matrix Circuit Our electronic FIGS. 1 & 2 keyboards 100,200,300,400,500,600 used in synthesizers, electronic organs, and digital pianos use sensor 59 Keys 85 and a keyboard 99 matrix 88 circuit in which eight rows and eight columns of wires 21 cross. In this way, 16 wires can provide (8×8) 64 crossings—sufficient for a full five octaves of range (61 notes). By scanning these crossings, a keyboard controller can determine which key was pressed. Digital piano 83, is an electronic musical instrument for synthesizing traditional piano timbre. With the development of digital signal processing and music synthesis algorithm, the music performance of digital piano 83 is rivaling the traditional piano. The piano use a novel piezoelectric material-Polyvinylidene Fluoride (PVDF) to capture the strength, velocity and duration of keystrokes to substitute the hammer and string of traditional piano. Timbre with different intension, duration is synthesized according to the keystroke information captured by the piezoelectric material.

### Piano

Pressing a key on the piano's keyboard 99 causes a felt padded hammer to strike steel strings. The hammers rebound, and the strings to continue to vibrate at their resonant frequency. These vibrations 61 are transmitted through a bridge 69 to a sounding board that more efficiently couples the acoustic energy to the air. The sound would otherwise be no louder than that directly produced by the strings. When the key 85 is released, a damper stops the string's vibration sound.

### Electric Instruments

The physical principle of the FIGS. 4 & 5 guitar 400,500 is therefore similar to the loudspeaker. The purpose of the piezoelectric resonator 33 is to produce a very loud sound, but the piezoelectric resonator 33 guitar will be played because of its distinctive tone. Piezoelectric Resonator 33 guitars may have either one or three resonator cones types (Tricone, Dobro, Biscuit) modified with antenna 25 tube 13 ultrasonic 55 amplifier 15 circuits 800,900,1000,1100.

Our electric guitars can have solid, semi-hollow, or hollow bodies, and produce little sound without amplification. Piezoelectric soundboard 20 sensors convert the vibration of the piezoelectric strings 21 into signals, which are fed to an amplifier resonator through a cable or radio transmitter. The sound is frequently modified by other electronic devices or the natural distortion of valves (vacuum tubes) in the amplifier resonator 15,33.

Referring to FIGS. 3-7, matrix antenna piezoelectric sensor 59 tube 13 transducers 300,400,500 in accordance with the present invention is shown comprising bulb 13, optional filament 21, grid 22, cathode 23, plate 24, antenna 25 and piezoelectric stack base 11. The FIGS. 6-7 handheld 600,700 interactive 63 houses a power control unit 800,900,1000,1100, a frequency power circuit unit resonator 15, octave 75 controller 39 and a function mode display unit 17,37.

The FIGS. 8-11 power control unit 800-1100 comprises a dynamo (11,13,25), a rectifier 1, charging circuit 2, an AC 26 supply charging circuit 3, a power lighting circuit 4, and a LED lamp 5. Antenna 25 tube 13 transducers 13 is coupled to the piezoelectric 11 through a bond set 12. The rectifier 1 is comprised of diodes D11-D16 and adapted to rectify AC 26 into DC 27. The antenna 25 vessel tube 13 charging circuit 2 is comprised of a transistor Q16 and a Zener diode ZD2. The antenna tube transducer (11,13,25) charging circuit 2 is on when the dynamo (11,13,25) is on, continual. While the tube vessel 13 dynamo (11,13,25) is working, the antenna 25 charging circuit 2 is driven to charge the battery 14 with the output DC 27 power supply of the dynamo (11,13,25). The AC 26 supply charging circuit 3 is comprised of a transistor Q11 and an electric connector 140, and electrically 31 connect able to the socket 21 of a power adapter 333, which is connect able to electric 31 service supply for enabling the AC 26 supply charging circuit 3 to charge the battery 14 with electric 31 service supply. The lighting circuit 4 is comprised of a transistor Q12, which is turned on or turns off. The LED lamp 5 is comprised of multiple LEDs (Light Emitting Diodes).

Further, the LED lamp 5 and the power lighting circuit 4 are electrically connected in series to a selector switch S1, which can be switched between a first mode where the LED lamp 5 is automatically turned on, and a second mode where the LED lamp 5 is turned on constantly so that the multipurpose Receiver 32 is used as a light source. Thus, the circuit unit Resonator 15 is adapted to receive converted DC 27 from power broadcasting signals 28, etc. The function mode display (LED) unit 17 has a speaker 16 for voice output, a screen 18 for data display, and selector key 19 for frequency selection. FIG. 10 Amplifier 1000 consists of C1-2, T1-2 and R1-5.

The oscillating 45 circuits 300-1100 receiver 32 a signal 28 at a frequency 101 of, for instance, 75 kHz as resonant frequency 101 of the piezoelectric 11 transducer 10 anode 51 (determined by the length direction dimension) or the neighborhood (±5 kHz) of the resonant frequency 101.

### Description of Alternate Embodiments

According to another aspect of the FIGS. 6-11 present invention, the multipurpose “Pizoe” headstock 81 receiver comprises a self recharging phone 60 or ballast 56 with processor 41, controller 39, resistor 36, touchscreen 37, transistor 35, power inverter 42, capacitor 38, diodes 44, rectifier 43, transceiver 58, sensor 59, microphone 66, voice commands 67, camera 68, transformer 73. Silicon 72 is a semiconductor. It has a negative temperature coefficient of resistance, since the number of free charge carriers increases with temperature. The electrical resistance of single crystal silicon 72 significantly changes under the application of mechanical stress due to the piezoresistive effect. The coated glass bulbs 57 have a white or gray powdery substance on the inside called kaolin 52, phosphor 53 or getter 54. Kaolin, that is blown in and electrostaticlly deposited on the interior of the bulb 57 within Piezoelectric resonator, string wires and sensor.

Without a matrix 300 circuit 88, a 61-key keyboard would require 62 wires 21 to connect (one for each note, and a ground)—an awkwardly thick bundle of wiring. With a matrix 300 circuit 88, any of 61 notes can be determined with only 16 wires. This is drawn schematically as a matrix of 8 columns and 8 rows of wires, with a switch at every intersection. The FIGS. 1 & 2 keyboard 100, 200 controller 39 scans the columns. If a key 59 has been pressed, the controller scans the rows, the controller determines the row-column combination at which a key has been pressed, and generates a note corresponding to that key 59. This process occurs so quickly that the performer is unaware of any delay

There are at least two limitations with this system. The first is that it provides only a crude binary on/off signal for each key. Better electronic keyboards employ two sets of switches for each key that are slightly offset. By determining the timing between the activation of the first and second switches, the velocity of a key press can be determined—greatly improving the performance dynamic of a keyboard. The second is that instruments with a matrix circuit can only play in a monophonic fashion without the addition of a diode for each key crossing. The diode is a one-way valve which prevents unwanted notes (“phantom keys”) from being triggered, or intended notes from being masked (“phantom key blocking”).

Monophonic instruments and most low-cost computer keyboards reduce costs by leaving out most or all of those diodes. To avoid “phantom keys”, the keyboard controller in modern low-cost computer keyboards will ignore further key presses once two keys (other than modifier keys) have been pressed, which is known as jamming.

These additionally can consist of passive components such as potentiometers and capacitors, but may also include specialized integrated Media player 65 circuits or other active components requiring batteries for power, for pre-amplification and signal processing, or even for assistance in tuning.

From the foregoing description, one skilled in the art can easily ascertain the essential characteristics of this invention, and without departing from the spirit and scope thereof, can make various changes and modifications of the invention to adapt it to various usages and conditions.

I claim:

1. A method of ultrasonic frequency transition where energy is transmitted, received, amplified, capacitated for the continuance electro battery charging and operation of appliances, machinery, transportation, vehicles, electronics and where:
(a) an ultrasonic frequency receiver comprising: a power control unit, said power control unit comprising a dynamo, Antenna within a piezoelectric vacuum tube transmission coupled to said dynamo to generate electricity, a rechargeable battery, a rectifier comprised of a plurality of diodes electrically connected between said dynamo and said rechargeable battery and adapted to rectify AC into DC, antenna vessel piezoelectric transducer power frequency charging circuit comprised of a transistor and a Zener diode and electrically connected between said rectifier and said rechargeable battery for charging said rechargeable battery during operation of said dynamo, adapter for converting electric service supply into DC power supply, a electric service AC supply charging circuit comprised of a transistor and an electric connector and adapted to charge said rechargeable battery with electric service supply, a LED lamp comprised of a plurality of light emitting diodes and, lighting circuit comprised of a transistor is turned on constantly where a resonator circuit unit adapted to receive converted DC from power frequency broadcasting signals, and has a function mode display unit, said function mode display unit comprising a speaker for voice output, a screen for data display, and a selector key for frequency selection; and
(b) a Matrix Transducer system of ultrasonic frequency reception and conversion to current, phone device for converting power frequency energy into direct current for generating electric power, oscillation apparatus comprising: antenna input for receiving frequency energy; headstock media interactive player for converting power frequency energy into direct current for generating electric power, resonator oscillation with antenna input for receiving frequency energy.

2. I claim the invention of an antenna grid piezoelectric vessel tube sensor resonator matrix when charged and amplified provides transistor and music means when said are combined with strings, soundboard, diaphragms, bridges, piezoelectric materials: and
(a) a stringed musical instrument comprising a body formed of vibratory material, a plurality of thin piezoelectric diaphragms loosely supported in and below the top of said body, a soundboard having triple arms connecting said diaphragms and extending through an opening in the top of the body, and a plurality of strings held in tension on said body and in contact with an arm of said soundboard for communicating the vibrations set up in the strings to said diaphragms and said body sound amplifying means, a hollow resonant sub-support for said diaphragm which lies in direct contact therewith, a portion of the wall of one of which within the line of contact has been removed to allow the adjacent contacting wall to form a single partition and common sounding board within said line, allowing the more ready transmission of sound there-through for the purpose of amplification, and means to initiate sound vibrations to be amplified thereby; and
(b) an instrument comprising a hollow body having an opening in the top thereof, an annular ring depending from the top and below said opening, a conical sensor resonator supported within said ring with its base downwardly, a neck piece extending longitudinally from said body, strings attached to said neck piece and stretched over said body, and a bridge engaging the upper portion of said resonator at its inner side and said strings for holding the strings and the resonator in tension, whereby vibrations may be transmitted from the instrument to the resonator; and
(c) a musical instrument comprising a hollow body having a well, an annular ring arranged in said well, and a conical piezoelectric resonator supported on said ring and directed downwardly, said resonator having radial ribs thereon, said ribs being of decreasing depth downwardly; and
(d) a stringed musical instrument comprising a body having a resonator thereon, radial ribs on said resonator, and soundboard with matrix engaging said resonator and said ribs.

3. A method of en-harmonic natural minor modifying a piano to provide a keyboard, said piano comprising a key configuration and a plurality of keys having striking sensors, said keyboard comprising a string and a plurality of diodes wherein at least some adjacent keys are spaced by a first distance, comprising the steps of: adding a plurality of said keys; and
(a) changing the spacing of at least some of said keys; and inserting a plurality of said keys with an en-harmonic natural minor replacement keys having striking sections with different widths than the striking sections of said first keys.
